(19) United States
(12) Patent Application Publication
(10) Pub. No.: US 2026/0074480 A1
(43) Pub. Date: Mar. 12, 2026

(54) Core Pumping High Power Doped Fiber Amplifier Realizing Full Band Gain Flatness

(71) Applicant: II-VI Photonics, Inc., Fuzhou (CN)

(72) Inventors: Chunli Tao, Fuzhou (CN); Yongjun Fu, Fuzhou (CN); Jianhua Fu, Fuzhou (CN)

(21) Appl. No.: 18/889,510

(22) Filed: Sep. 19, 2024

(30) Foreign Application Priority Data
Sep. 6, 2024 (CN) 202411251674.9

(51) Int. Cl. H01S 3/094; H01S 3/067; H01S 3/16

(52) U.S. Cl. CPC H01S 3/094011; H01S 3/06716; H01S 3/094096; H01S 3/1608

(57) ABSTRACT

In a method and system for generating high gain and increased output power in a doped fiber amplifier, a first pair of wavelengths of pump laser light are injected into an active optical fiber between an input end and an output end of the active optical fiber in a co-propagating direction, toward the output end of the active optical fiber, as one or more communication wavelengths of signal light from the input end to the output end of the active optical fiber. A second pair of wavelengths of pump laser light are injected into the active optical fiber between the input end and the output end of the active optical fiber in a counter-propagating direction, toward the input end of the active optical fiber, as the one or more communication wavelengths of signal light from the input end to the output end of the active optical fiber.

### CROSS-REFERENCE TO RELATED APPLICATION

This application claims priority to Chinese Patent Application No. 202411251674.9 filed Sep. 6, 2024, the disclosure of which is hereby incorporated by reference in its entirety.

### BACKGROUND OF THE INVENTION

### 1) Field of the Invention

The present disclosure relates to a system and method for generating high gain and increased output power in a doped fiber amplifier.

### 2) Description of Related Art

Higher power erbium doped fiber amplifiers (EDFAs) are required constantly in the market, but are limited by a single pump laser's upper power. A common EDFA maximum output power is about 25 dBm.

The existing solution is to utilize or erbium-ytterbium doped fiber amplifiers EYDFAs to generate high gain and increased output power up to 30 dBm. A disadvantage of the existing solution is that EYDFAs can only cover a wavelength range from 1540 nm to 1565 nm, i.e., less than the wavelength range of the full C-band.

It would, therefore, be desirable to increase the output power of EDFAs while, simultaneously, covering the full C-band, i.e., from 1525 nm to 1565 nm. This will allow more signal light to be amplified and transmitted than existing solutions.

### SUMMARY OF THE INVENTION

Disclosed is a method of amplification in an optical fiber having an input end for receiving one or more communication wavelengths of signal light and an output end for outputting the one or more communication wavelengths of signal light. The method comprises: (a) injecting into the optical fiber, by a first pair of pump lasers, between the input end and the output end of the optical fiber, a first pair of wavelengths of pump laser light in a co-propagating direction, toward the output end of the optical fiber, as the signal light from the input end to the output end of the optical fiber; and (b) injecting into the optical fiber, by a second pair of pump lasers, between the input end and the output end of the optical fiber, a second pair of wavelengths of pump laser light in a counter-propagating direction, toward the input end of the optical fiber, as the signal light from the input end to the output end of the optical fiber. The first pair of wavelengths of pump laser light includes a first wavelength in a wavelength range between 1470 nm and 1490 nm and a second wavelength in a wavelength range between 968 nm and 982 nm. The second pair of wavelengths of pump laser light includes a third wavelength in a wavelength range between 968 nm and 982 nm and a fourth wavelength in a wavelength range between 1470 nm and 1490 nm.

Also disclosed is a system for amplifying one or more communication wavelengths of signal light. The system comprises a booster amplifier including: an active optical fiber coupled to receive and propagate one or more communication wavelengths of signal light in a downstream direction in the active optical fiber; a first pair of pump lasers for injecting into the active optical fiber a first pair of wavelengths of pump laser light in the downstream direction in the active optical fiber; and a second pair of pump lasers injecting into the active optical fiber a second pair of wavelengths of pump laser light in an upstream direction in the active optical fiber. The first pair of wavelengths of pump laser light includes a first wavelength in a wavelength range between 1470 nm and 1490 nm and a second wavelength in a wavelength range between 968 nm and 982 nm. The second pair of wavelengths of pump laser light includes a third wavelength in a wavelength range between 968 nm and 982 nm and a fourth wavelength in a wavelength range between 1470 nm and 1490 nm.

### BRIEF DESCRIPTION OF THE DRAWINGS

FIG. 1 is a schematic of an example optical fiber transmission system including a booster amplifier in accordance with the principles of the present disclosure; and

FIG. 2 is a method in accordance with the principles of the present disclosure.

### DESCRIPTION OF THE INVENTION

As used herein, spatial, or directional terms, such as “left”, “right”, “inner”, “outer”, “above”, “below”, and the like, relate to the disclosure as it is shown in the drawing figures. However, it is to be understood that the disclosure can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “approximately” or “about”. Accordingly, unless indicated to the contrary, the numerical values set forth in the following specification and claims may vary depending upon the desired properties sought to be obtained by the present disclosure.

At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. “A” or “an” refers to one or more.

As used herein, “coupled”, “coupling”, and similar terms refer to two or more elements that are joined, linked, fastened, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the phrase “at least one of”, when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations.

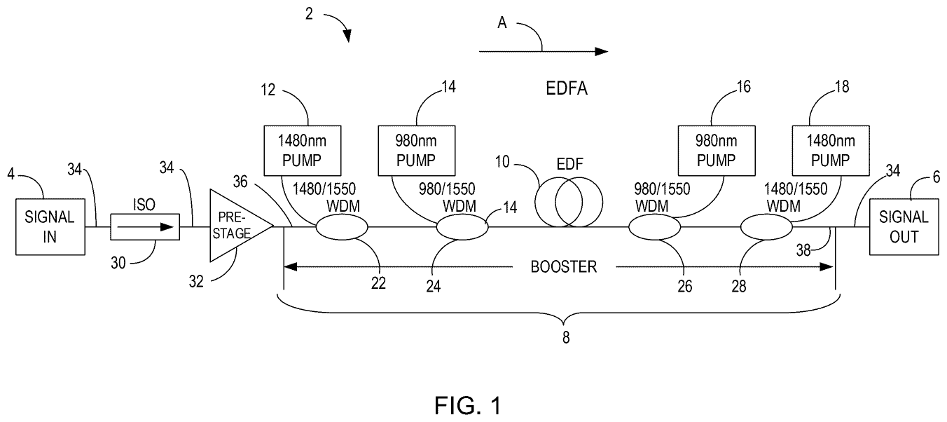

With reference to FIG. 1, an example optical fiber transmission system 2 in accordance with the principles of the present disclosure includes an input (or signal in) end 4 for receiving and propagating one or more communication wavelengths of signal light in a downstream direction (shown by arrow A in FIG. 1) to an output (or signal out) end 6 at an opposite end of the optical fiber transmission system 2.

The example optical fiber transmission system 2 may include a booster amplifier 8 between the input end 4 and output end 6 of the optical fiber transmission system 2. The booster amplifier 8 may include an active optical fiber 10 coupled to receive and propagate one or more communication wavelengths of signal light (hereinafter, sometimes referred to simply as “signal light”) in the downstream direction from the input end 4 to the output end 6 of the optical fiber transmission system 2. The one or more communication wavelengths of signal light may include one or more wavelengths in one or more of the following bands: a C band, an L band, an S band, an O band, and E band or a U band. For the purpose of this description, t he one or more communication wavelengths of signal light may be described as being in the C band (i.e., between 1525 and 1565 nm wavelengths), with a wavelength of 1550 nm being used as one non-limiting example of a wavelength in the C band. However, this is not to be construed as limiting the present disclosure.

In this example, the booster amplifier 8 may include a first pair of pump lasers 12 and 14 for injecting into the active optical fiber 10 a first pair of wavelengths of pump laser light in the downstream direction in the active optical fiber 10, i.e., in a co-propagating direction as the signal light in the active optical fiber 10. The first pair of wavelengths of pump laser light may include a first wavelength in a wavelength range between 1470 nm and 1490 nm and a second wavelength in a wavelength range between 968 nm and 982 nm injected into the active optical fiber 10 by the first pair of pump lasers 12 and 14, respectively.

The booster amplifier 8 may also include a second pair of pump lasers 16 and 18 for injecting into the active optical fiber a second pair of wavelengths of pump laser light in an upstream direction in the active optical fiber 10, i.e., in a counter-propagating direction as the signal light in the active optical fiber 10. The second pair of wavelengths of pump laser light may include a third wavelength in a wavelength range between 968 nm and 982 nm and a fourth wavelength in a wavelength range between 1470 nm and 1490 nm injected into the active optical fiber 10 by the second pair of pump lasers 16 and 18, respectively.

In an example, the first—fourth wavelengths of pump laser light may be pulse width modulation injected into the active optical fiber 10. However, this is not to be construed in a limiting sense. In an example, the first—fourth wavelengths of pump laser light may be simultaneously present on the active optical fiber 10 with the at least one or more communication wavelengths of the signal light.

In the example shown in FIG. 1, the communication wavelength of signal light may be 1550 nm, the first wavelength of pump laser light injected into the active optical fiber 10 by the pump laser 12 may have a wavelength of 1480 nm, the second wavelength of pump laser light injected into the active optical fiber 10 by the pump laser 14 may have a wavelength of 980 nm, the third wavelength of pump laser light injected into the active optical fiber 10 by the pump laser 16 may have a wavelength of 980 nm, and the fourth wavelength of pump laser light injected into the active optical fiber 10 by the pump laser 18 may have a wavelength of 1480 nm.

However, this is not to be construed as limiting the present disclosure since it is envisioned that the communication wavelength of signal light may have any wavelength in the C band, e.g., between 1525 nm and 1565 nm wavelength(s), the pump laser 12 may inject into the active optical fiber 10 any wavelength of pump laser light between 1470 nm and 1490 nm, the pump laser 14 may inject into the active optical fiber 10 any wavelength of pump laser light between 968 nm and 982 nm, the pump laser 16 may inject into the active optical fiber 10 any wavelength of pump laser light between 968 nm and 982 nm, and the pump laser 18 may inject into the active optical fiber 10 any wavelength of pump laser light between 1470 nm and 1490 nm. In an example, the first and fourth wavelengths of pump laser light may be same or different and the second and third wavelengths of pump laser light may be same or different.

In an example, the first wavelength of pump laser light may be 1480nm±5 nm; the second wavelength of pump laser light may be 975nm±5 nm; the third wavelength of pump laser light may be 975nm±5 nm; and the fourth wavelength of pump laser light may be 1480nm±5 nm. However, this is not to be construed in a limiting sense.

In the example shown in FIG. 1, the first pair of pump lasers 12 and 14 are positioned closer to the input end 4 of the optical fiber transmission system 2 than the second pair of pump lasers 16 and 18 and the second pair of pump lasers 16 and 18 are positioned closer to the output end 6 of the optical fiber transmission system 2 than the first pair of pump lasers 12 and 14. However, the order and location of pump lasers 12, 14, 16 and 18 from left to right in FIG. 1 is not to be construed in a limiting sense since it is envisioned that pump lasers 12, 14, 16 and 18 may be positioned in any order or location along the length of the active optical fiber 10 to inject the first pair of wavelengths of pump laser light in the downstream direction in the active optical fiber 10 and to inject the second pair of wavelengths of pump laser light in the upstream direction in the active optical fiber 10.

Each wavelength of pump laser light may be injected by its pump laser into the active optical fiber 10 via a separate combiner or multiplexer (e.g., a wavelength division multiplexer (WDM)) which combines the wavelength of the injected pump laser light with the one or more communication wavelengths of signal light and, as appropriate, any pump laser light injected into the active optical fiber 10 by another pump laser. In an example, the first wavelength of pump laser light output by the pump laser 12 may be injected into the active optical fiber 10 by via a WDM 22, the second wavelength of pump laser light output by the pump laser 14 may be injected into the active optical fiber 10 by via a WDM 24, the third wavelength of pump laser light output by the pump laser 16 may be injected into the active optical fiber 10 by via a WDM 26, and the fourth wavelength of pump laser light output by the pump laser 18 may be injected into the active optical fiber 10 by via a WDM 28. In an example, injecting the first and second pairs of wavelengths of pump laser light into the active optical fiber 10 may produce gain in the one or more communication wavelengths of the signal light propagating in the active optical fiber 10.

In the example shown in FIG. 1 the active optical fiber 10 is an erbium doped optical fiber (EDFA). However, this is not to be construed in a limiting sense since it is envisioned that the active optical fiber 10 may doped with any one or more or some combination of the following: erbium, bismuth, praseodymium, thulium, ytterbium, holmium, dysprosium, and neodymium.

The example optical fiber transmission system 2 may also include an optional optical isolator (ISO) 30 for optically isolating the one or more communication wavelengths of signal light input into the input end 4 prior to being received by the booster amplifier 8 and/or a pre-stage amplifier 32 for amplifying the one or more communication wavelengths of signal light prior to being received by the booster amplifier 8. In an example, the pre-stage amplifier 32 may have an output power of at least 27 dBm relative to the input power of the one or more communication wavelengths of signal light propagating in the example optical fiber transmission system 2. The order of the ISO 30 and the pre-stage amplifier 32 shown in FIG. 1 is not to be construed in a limiting sense since it is envisioned that the order ISO 30 and the pre-stage amplifier 32 shown in FIG. 1 may be reversed.

In an example, the active optical fiber 10 may have a pump conversion efficiency greater than 0.5, 0.51, or 0.52 when the pump power is greater than 500 mW. In an example, the pre-stage amplifier 32 may have a high inversion between 0.6 and 0.95.

The example optical fiber transmission system 2 shown in FIG. 1 may include one or more optical fibers 34 which may not be active optical fibers, e.g., optical fibers 34 may be undoped or passive optical fibers, which are coupled to an input end 36 and an output end 38 of the active optical fiber 10 of the booster amplifier 8. However, this is not to be construed in a limiting sense since it is envisioned that, where the ISO 30 and the pre-stage amplifier 32 are not included or are absent in the optical fiber transmission system 2, the input end 36 and the output end 38 of the active optical fiber 10 may be the same as the an input end 4 and the output end 6 of the optical fiber transmission system 2.

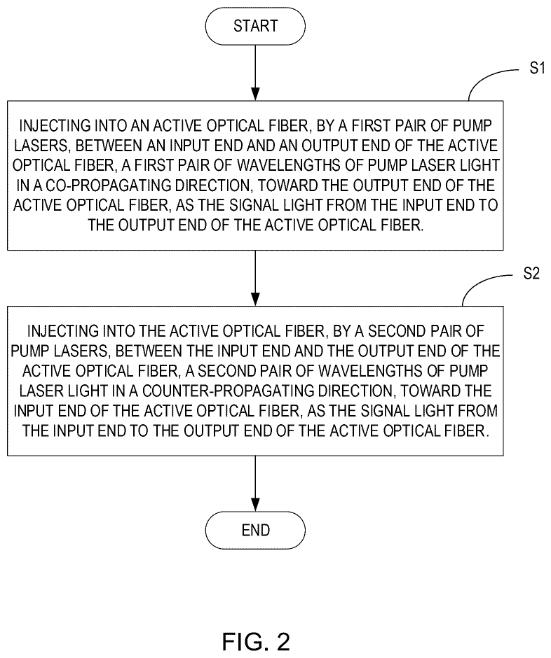

With reference to FIG. 2 and with continuing reference to FIG. 1, a method in accordance with the principles of the present disclosure may include a step S1 wherein a first pair of wavelengths of pump laser light are injected into the active optical fiber 10, by a first pair of pump lasers 12 and 14, between the input end 36 and the output end 38 of the active optical fiber 10 in a co-propagating direction, toward the output end 38 of the active optical fiber 10, as the one or more communication wavelengths of signal light from the input end 36 to the output end 38 of the active optical fiber 10.

The method may also include a step S2 wherein a second pair of wavelengths of pump laser light are injected into the active optical fiber 10, by a second pair of pump lasers 16 and 18, between the input end 36 and the output end 38 of the active optical fiber 10 in a counter-propagating direction, toward the input end 36 of the active optical fiber 10, as the one or more communication wavelengths of signal light from the input end 36 to the output end 38 of the active optical fiber 10.

In an example, steps S1 and S2 may occur simultaneously. According, the order of steps S1 and S2 shown in FIG. 2 is not to be construed in a limiting sense.

Other non-limiting aspects of this disclosure are set forth in the following illustrative and exemplary numbered clauses:
Clause 1: In a method of amplification in an optical fiber having an input end for receiving one or more communication wavelengths of signal light and an output end for outputting the one or more communication wavelengths of signal light, the method comprises: (a) injecting into the optical fiber, by a first pair of pump lasers, between the input end and the output end of the optical fiber, a first pair of wavelengths of pump laser light in a co-propagating direction, toward the output end of the optical fiber, as the signal light from the input end to the output end of the optical fiber; and (b) injecting into the optical fiber, by a second pair of pump lasers, between the input end and the output end of the optical fiber, a second pair of wavelengths of pump laser light in a counter-propagating direction, toward the input end of the optical fiber, as the signal light from the input end to the output end of the optical fiber. The first pair of wavelengths of pump laser light includes a first wavelength in a wavelength range between 1470 nm and 1490 nm and a second wavelength in a wavelength range between 968 nm and 982 nm. The second pair of wavelengths of pump laser light includes a third wavelength in a wavelength range between 968 nm and 982 nm and a fourth wavelength in a wavelength range between 1470 nm and 1490 nm.
Clause 2: The method of clause 1, wherein the one or more communication wavelengths of signal light may include one or more wavelengths in one or more of a C band, an L band, an S band, an O band, an E band or a U band.
Clause 3: The method of clause 1 or 2, wherein the first and fourth wavelengths may be the same or different.
Clause 4: The method of any one of clauses 1-3, wherein the second and third wavelengths may be the same or different.
Clause 5: The method of any one of clauses 1-4, wherein at least one of the first - fourth wavelengths of pump laser light may be pulse width modulation injected into the optical fiber.
Clause 6: The method of any one of clauses 1-5, wherein the optical fiber may be an active optical fiber.
Clause 7: The method of any one of clauses 1-6, wherein the active optical fiber may be doped with one or more of the following: erbium, bismuth, praseodymium, thulium, ytterbium, holmium, dysprosium, neodymium.
Clause 8: The method of any one of clauses 1-7, wherein: the first pair of pump lasers may be positioned closer to the input end of the optical fiber than the second pair of pump lasers; and the second pair of pump lasers may be positioned closer to the output end of the optical fiber than the first pair of pump lasers.
Clause 9: The method of any one of clauses 1-8, wherein, from the input end of the optical fiber to the output end of the optical fiber, the wavelengths of pump laser light may be injected into the optical fiber in the following order: the first wavelength of pump laser light, the second wavelength of pump laser light, the third wavelength of pump laser light, and the fourth wavelength of pump laser light.
Clause 10: The method of any one of clauses 1-9, wherein injecting the first and second pairs of wavelengths of pump laser light into the optical fiber may produce gain in the one or more communication wavelengths of the signal light.
Clause 11: The method of any one of clauses 1-10, wherein each wavelength of pump laser light may be injected into the optical fiber via a separate combiner or multiplexer which combines the wavelength of the injected pump laser light with the at least one or more communication wavelengths of signal light propagating in the optical fiber.
Clause 12: The method of any one of clauses 1-11, wherein, via the combiners or multiplexers, the first—fourth wavelengths of pump laser light may be simultaneously present on the optical fiber with the at least one or more communication wavelengths of signal light.
Clause 13: The method of any one of clauses 1-12, wherein a pre-stage amplifier may have an inversion between 0.6 and 0.95.
Clause 14: In a system for amplifying one or more communication wavelengths of signal light, the system comprises a booster amplifier including: an active optical fiber coupled to receive and propagate one or more communication wavelengths of signal light in a downstream direction in the active optical fiber; a first pair of pump lasers for injecting into the active optical fiber a first pair of wavelengths of pump laser light in the downstream direction in the active optical fiber; and a second pair of pump lasers injecting into the active optical fiber a second pair of wavelengths of pump laser light in an upstream direction in the active optical fiber. The first pair of wavelengths of pump laser light includes a first wavelength in a wavelength range between 1470 nm and 1490 nm and a second wavelength in a wavelength range between 968 nm and 982 nm. The second pair of wavelengths of pump laser light includes a third wavelength in a wavelength range between 968 nm and 982 nm and a fourth wavelength in a wavelength range between 1470 nm and 1490 nm.
Clause 15: The system of clause 14, wherein the system may include at least one of the following: an optical isolator for optically isolating the one or more communication wavelengths of signal light prior to being received by the booster amplifier; and a pre-stage amplifier for amplifying the one or more communication wavelengths of signal light prior to being received by the booster amplifier.
Clause 16: The system of clause 14 or 15, wherein each wavelength of pump laser light may be injected into the active optical fiber via a separate combiner or multiplexer which combines the wavelength of the injected pump laser light with the one or more communication wavelengths of signal light.
Clause 17: The system of any one of clauses 14-16, wherein the one or more communication wavelengths of signal light may include one or more wavelengths in one or more of the following bands: a C band, an L band, an S band, an O band, and E band or a U band.18.
Clause 18: The system of any one of clauses 14-17, wherein: the first pair of pump lasers may include a first pump laser injecting the first wavelength and a second pump laser injecting the second wavelength; and the second pair of pump lasers may include a third pump laser injecting the third wavelength and a fourth pump laser injecting the fourth wavelength,
Clause 19: The system of any one of clauses 14-18, wherein, moving in the downstream direction, the pump lasers may be optically coupled to the active optical fiber in the following order: the first pump laser, the second pump laser, the third pump laser, and the fourth pump laser.
Clause 20: The system of any one of clauses 14-19, wherein: the first wavelength may be 1480nm±5 nm; the second wavelength may be 975nm±5 nm; the third wavelength may be 975nm±5 nm; and the fourth wavelength may be 1480nm±5 nm.
Clause 21: The system of any one of clauses 14-20, wherein the active optical fiber may be doped with one or more of the following: erbium, bismuth, praseodymium, thulium, ytterbium, holmium, dysprosium, and neodymium.
Clause 22: The system of any one of clauses 14-21, wherein the active optical fiber may have a pump conversion efficiency greater than 0.5, 0.51, or 0.52 when the pump power is greater than 500 mW.

The system and method described herein may increase the booster amplifier's output power to more than 32 dBm and may realize full gain flatness at least in at least the C band, but may also or alternatively realize full gain flatness in one or more of the L band, the S band, the O band, the E band, or the U band.

Although this disclosure has been described in detail for the purpose of illustration based on what is currently considered to be the most practical and preferred embodiments, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

1. A method of amplification in an optical fiber having an input end for receiving one or more communication wavelengths of signal light and an output end for outputting the one or more communication wavelengths of signal light, the method comprising:
(a) injecting into the optical fiber, by a first pair of pump lasers, between the input end and the output end of the optical fiber, a first pair of wavelengths of pump laser light in a co-propagating direction, toward the output end of the optical fiber, as the signal light propagating from the input end to the output end of the optical fiber; and
(b) injecting into the optical fiber, by a second pair of pump lasers, between the input end and the output end of the optical fiber, a second pair of wavelengths of pump laser light in a counter-propagating direction, toward the input end of the optical fiber, as the signal light propagating from the input end to the output end of the optical fiber, wherein:
the first pair of wavelengths of pump laser light includes a first wavelength in a wavelength range between 1470 nm and 1490 nm and a second wavelength in a wavelength range between 968 nm and 982 nm; and
the second pair of wavelengths of pump laser light includes a third wavelength in a wavelength range between 968 nm and 982 nm and a fourth wavelength in a wavelength range between 1470 nm and 1490 nm.

2. The method of claim 1, wherein the one or more communication wavelengths of signal light includes one or more wavelengths in one or more of a C band, an L band, an S band, an O band, an E band or a U band.

3. The method of claim 1, wherein at least one of:
the first and fourth wavelengths are the same; and
the second and third wavelengths are the same.

4. The method of claim 1, wherein at least one of:
the first and fourth wavelengths are different; and
the second and third wavelengths are different.

5. The method of claim 1, wherein at least one of the first - fourth wavelengths of pump laser light are pulse width modulation injected into the optical fiber.

6. The method of claim 1, wherein the optical fiber is an active optical fiber.

7. The method of claim 6, wherein the active optical fiber is doped with one or more of the following: erbium, bismuth, praseodymium, thulium, ytterbium, holmium, dysprosium, neodymium.

8. The method of claim 1, wherein:
the first pair of pump lasers are positioned closer to the input end of the optical fiber than the second pair of pump lasers; and
the second pair of pump lasers are positioned closer to the output end of the optical fiber than the first pair of pump lasers.

9. The method of claim 1, wherein, from the input end of the optical fiber to the output end of the optical fiber, the wavelengths of pump laser light are injected into the optical fiber in the following order: the first wavelength of pump laser light, the second wavelength of pump laser light, the third wavelength of pump laser light, and the fourth wavelength of pump laser light.

10. The method of claim 1, wherein injecting the first and second pairs of wavelengths of pump laser light into the optical fiber produces gain in the one or more communication wavelengths of the signal light.

11. The method of claim 1, wherein each wavelength of pump laser light is injected into the optical fiber via a separate combiner or multiplexer which combines the wavelength of the injected pump laser light with the at least one or more communication wavelengths of signal light propagating in the optical fiber.

12. The method of claim 11, wherein, via the combiners or multiplexers, the first—fourth wavelengths of pump laser light are simultaneously present on the optical fiber with the at least one or more communication wavelengths of signal light.

13. The method of claim 1, wherein a pre-stage amplifier has an inversion between 0.6 and 0.95.

14. A system for amplifying one or more communication wavelengths of signal light, the system comprising a booster amplifier including:
an active optical fiber coupled to receive and propagate one or more communication wavelengths of signal light in a downstream direction in the active optical fiber;
a first pair of pump lasers for injecting into the active optical fiber a first pair of wavelengths of pump laser light in the downstream direction in the active optical fiber; and
a second pair of pump lasers injecting into the active optical fiber a second pair of wavelengths of pump laser light in an upstream direction in the active optical fiber, wherein:
the first pair of wavelengths of pump laser light includes a first wavelength in a wavelength range between 1470 nm and 1490 nm and a second wavelength in a wavelength range between 968 nm and 982 nm; and
the second pair of wavelengths of pump laser light includes a third wavelength in a wavelength range between 968 nm and 982 nm and a fourth wavelength in a wavelength range between 1470 nm and 1490 nm.

15. The system of claim 14, further including at least one of the following:
an optical isolator for optically isolating the one or more communication wavelengths of signal light prior to being received by the booster amplifier; and
a pre-stage amplifier for amplifying the one or more communication wavelengths of signal light prior to being received by the booster amplifier.

16. The system of claim 14, wherein each wavelength of pump laser light is injected into the active optical fiber via a separate combiner or multiplexer which combines the wavelength of the injected pump laser light with the one or more communication wavelengths of signal light.

17. The system of claim 14, wherein the one or more communication wavelengths of signal light include one or more wavelengths in one or more of the following bands:
a C band, an L band, an S band, an O band, and E band or a U band.

18. The system of claim 14, wherein:
the first pair of pump lasers include a first pump laser injecting the first wavelength and a second pump laser injecting the second wavelength; and
the second pair of pump lasers include a third pump laser injecting the third wavelength and a fourth pump laser injecting the fourth wavelength.

19. The system of claim 18, wherein, moving in the downstream direction, the pump lasers are optically coupled to the active optical fiber in the following order: the first pump laser, the second pump laser, the third pump laser, and the fourth pump laser.

20. The system of claim 14, wherein:
the first wavelength is 1480 nm±5 nm;
the second wavelength is 975 nm±5 nm;
the third wavelength is 975 nm±5 nm; and
the fourth wavelength is 1480 nm±5 nm.

21. The system of claim 14, wherein the active optical fiber is doped with one or more of the following: erbium, bismuth, praseodymium, thulium, ytterbium, holmium, dysprosium, and neodymium.

22. The system of claim 14, wherein the active optical fiber has a pump conversion efficiency greater than 0.5, 0.51, or 0.52 when the pump power is greater than 500 mW.
